(19) United States
(12) Patent Application Publication
(10) Pub. No.: US 2003/0173339 A1
(43) Pub. Date: Sep. 18, 2003

(54) High temperature tooling

(76) Inventors: Paul Chalfont Fryer, Bedford (GB); Richard Paul Fryer, Bedford (GB); Jeremy Edward Fryer, Bedford (GB)

Correspondence Address: Darin J Gibby, Townsend and Townsend and Crew, 8th Floor, Two Embarcadero Center, San Francisco, CA, 94111-3834, US

(21) Appl. No.: 10/312,107

(22) PCT Filed: Jun. 7, 2001
(86) PCT No.: PCT/GB01/02501

(30) Foreign Application Priority Data
Jun. 21, 2000 (GB) 0015053.2

(51) Int. Cl. B23K 10/00

(52) U.S. Cl. 219/121.5; 219/121.48

(57) ABSTRACT

A thermal tool (100) for high temperature work such as plasma welding or cutting has a replaceable nozzle (102) coupled to an elongate support (106) via interengaging threaded portions (108, 110) on each. The threaded portions are tapered and good heat conduction is provided from the nozzle to the elongate support, giving the nozzle a longer life. The nozzle can be readily removed and changed. A fluid-cooling channel (120) is enclosed in the second part adjacent the interengaging threads, which may be buttresstype threads.

### DESCRIPTION

### TECHNICAL FIELD

The present invention relates to a thermal tool of a kind exposed to high temperatures during use which have a tendency to reduce tool life, and particularly but not exclusively to a welding tool.

### BACKGROUND ART

By their very nature, thermal joining and cutting tools operate at elevated temperatures, with a large part of the heat generated passing to the workpiece and surroundings. However, the tool tip adjacent the workpiece will experience similar temperatures to the workpiece itself, and frequently there is a need to dissipate heat energy through the tool body in order to increase the working life of the tool tip. In the case of thermal tooling for metal working and other similarly high temperature work, the tool tip may be cooled with a fluid coolant which circulates within the tool as close as possible to the tip. Even so, the tool tip may wear more rapidly than the remainder of the tool, and for this reason is usually replaceable.

Various replaceable parts used in the welding and cutting industry are attached to the main tool body using helical threads relying on the thread contact area or other abutting portions of the parts to transmit heat from the replaceable part to the area of the tool that is large enough to carry a cooling medium. The effectiveness of the cooling can have a marked effect on the life of the replaceable parts. Electrical power can also be transmitted through these connections. Replaceable tips of thermal joining and cutting tools may be of a “wet-change” kind or a “dry-change” kind, and examples of each are set out below.

Wet-Change

FIG. 1 shows schematically the working end of a plasma welding or cutting torch tool 10 which comprises replaceable tool tip or nozzle 12 attached to an elongate support 14 via mating screw-threads 16. The tool 10 generates an electric arc 18, extending from electrode 20 to workpiece 22. Gas 24 flowing through the nozzle 12 is ionised by the arc 18 and propelled at high speed to the workpiece 22. The speed of the ionised gas is chosen to either pierce/cut the workpiece (i.e. speed exceeds threshold value) or cause localised melting on the surface of the workpiece for joining parts together (i.e. speed is below threshold value). The temperature achieved near the nozzle can be as high as 50,000 Kelvin, and thus cooling of the nozzle 12 is of critical importance. In order to deliver coolant as close as possible to the heat source, the nozzle 12 includes an annular recess 27, which communicates with the fluid supply channels 26 in the support 14. Seals 28 prevent cooling fluid from contaminating the ionised gas when the tool 10 is in use. Nevertheless, when the nozzle 12 is worn out and has to be replaced, some fluid is spilt (hence the term “wet-change”) and the tool may need drying out before it is ready for reuse.

Dry-Change

FIG. 2 shows schematically the working end of the plasma welding or cutting torch 30 modified for dry-change of replacement nozzle 32. The torch 30 has an elongate support 34 which includes closed coolant fluid supply channels 36. With this arrangement, cooling fluid does not come into contact with the nozzle 32, and instead the fluid pathway ends in an annular chamber 38 adjacent a surface 40 which opposes a surface 41 of the nozzle 32. The arrangement relies upon conduction of heat across opposed surfaces 40,41, and any thread contact, towards annular chamber 38 before reaching the cooling fluid. Although the arrangement has the advantage of enabling “dry-changing” of the nozzle 32, there is the disadvantage that heat conducted from the nozzle 32 to the support 34 may be restricted unless the opposed surfaces are in intimate contact.

FIG. 3 shows schematically the working end of a MIG/MAG (metal inert gas/metal active gas) welding torch 50, as an alternative to the plasma torch tool 30 of FIG. 2. In use, an electric current is passed from the tool 50 to the contact tip or nozzle 52 and then to welding filler wire 53. The nozzle 52 is a replaceable part and is subject to heat from the welding arc and erosion from the filler wire 53 travelling through central aperture 55. The nozzle 52 is attached to an elongate support 54, which includes closed coolant fluid supply channels 56. The support 54 cools the nozzle 52 by supplying coolant to annular chamber 58, just as before in the FIG. 2 arrangement. Heat is conducted to the coolant fluid from the nozzle 52 through the mating screw-threads 60 and the opposed surfaces at step 62. The alignment of the central axis of the nozzle is important, and is mainly influenced by the step 62.

Known guide tubes for a consumable wire electrode for use in arc welding, according to GB Patent 1435427 and DE 2345182 (both in the name CLOOS), have threaded connections with a holder, which assists in transferring heat and electrical current to the wire electrode. The threaded portion of the guide tube may be narrowly tapered with a semi-angle of approximately 3.5°.

The present applicant has developed a novel coupling for attaching the replaceable part (e.g. nozzle) to the support part, which may help to extend the working life of the replaceable part by virtue of allowing improved cooling during tool use.

### DISCLOSURE OF THE INVENTION

In accordance with the present invention, there is provided a tool for thermally working a workpiece, comprising a first part which is heated (either directly or indirectly) during tool operation, and a second part configured to support and conduct heat away from the first art when heated during tool operation, the parts having complementary, screw-threaded portions, which interengage when the first part is supported by the second part, characterised in that the screw-threaded portion of one part has a substantially conical or frusto-conical profile with a cone semi-angle of at least 10°.

The present applicant has found that with such a profile, intimate contact between the first part and the second part is encouraged and extended. It is possible for both flanks of the screw-thread on one part to make contact with the respective flanks of the screw-thread on the other part. This provides a large contact area over the whole of the surface where the screw-threads interengage and allows rapid dissipation of heat from the first part. The large contact area, coupled with the intimacy of contact encouraged by a wedge-like action generated where the threads engage, offers minimal resistance to electrical or thermal conduction. This tends not to be the case with a conventional arrangement, employing a helical screw-threaded profile where the flank on only one side of the screw-thread is pulled up against an opposing flank, with a consequent lack of contact between the remaining flanks.

The present applicant has also found that with the proposed conical or frusto-conical profile, the axial and radial location of the threads is very precise. The axial precision results from the conical profile and the thread pitch; the radial precision is due to the conical profile.

The cone semi-angle of the conical or frusto-conical profile, which is based on a circular cone, is defined as the angle of inclination of the curved periphery to the central (screw) axis of the screw-threaded portion. The cone semi-angle is less than 89°, perhaps even less than 80°. The cone semi-angle may be 30°±5°. In practice, the semi-angle is selected such that when the torque required for coupling the first part to the second part is applied, any distortion of the parts is less than a critically detrimental amount. As the cone semi-angle of the first part increases beyond about 10°, the radial (bursting) pressure for a given torque decreases rapidly. Therefore, the risk of the parts jamming together to the point where they can no longer be readily separated is greatly reduced, perhaps even eliminated. Indeed, shallow tapered threaded portions (i.e. with a cone semi-angle of the order of a few degrees) have been used in the past to provide a near-permanent join between two parts, especially those made of copper and its alloys.

At least one of the screw-threads of the complementary portions may be a buttress type of screw-thread. The buttress type of screw-thread is herein defined as meaning (and employed as meaning) a screw-thread in which the front (or thrust) face is perpendicular to the screw axis; the back of the thread slopes at an angle to the screw axis, for example at an angle of about 45° to about 60°. In one embodiment, the back of the thread slopes at 60° to the screw axis. Of the many possible types of screw-thread, the buttress screw-thread assists secure coupling of the first and second parts together, and may be less susceptible to damage than other thread forms. The thread tips may be truncated (e.g. provided with flats) to increase robustness by avoiding a sharp edge which is easily damaged. The use of a buttress type screw-thread on the conical or frusto-conical profile results in increased thread flank area in comparison to other types of screw-thread. An increase in thread flank area is desirable as it increases contact area between the first and second parts, leading to improved thermal/electrical conduction between the parts.

A heat sink may be provided adjacent the screw-threaded portion of the second part. The specified range of cone semi-angles enables the heat sink to be located as close as possible to where the heat is being generated, thus enabling the first and second parts to have a similar-sized footprint (cross-sectional area), as viewed end-on, e.g. from the direction of the workpiece.

The second part may include a fluid supply conduit through which fluid may be circulated to facilitate cooling of the first part. The fluid supply conduit may terminate within the second part, perhaps adjacent the interengaging screw-threaded portions. In this way, dry-changing of the first part with a replacement part is possible. The improved conductivity between the first and second parts obviates the need for wet-changing.

The first part may have a tip region which is fully exposed during use so that heat transfer from the first part to the second part is maximised. The thermal tool of the invention may produce a working temperature of the order of 50,000K and consequently the tip region may be required to tolerate temperatures up to 1000K. The tip region may be the tip of a conical portion which leads to the screw-threaded portion.

The tool may be a welding tool or a cutting tool. The welding tool may be selected from the group consisting of a plasma welding torch, a plasma cutting torch, a laser welding device, a laser cutting device, a MIG welding torch, a MAG welding torch, a spot (resistance) welding device, a TIG welding torch, and combinations thereof.

The first part may be a male part, having a screw-threaded portion with the conical or frusto-conical profile. In this way, the second part may be a female part, having a complementary screw-threaded portion with a conical or frusto-conical recess for receiving the aforementioned profile of the first part.

The specified range of cone semi-angles facilitates replacement of the first part, which may be desirable in situations where the first part is sacrificial because it is exposed to a harsh environment where wear or erosion limit working life. Not only does the present invention alleviate, even obviate, the risk of parts jamming together, but also it offers the potential for quick-fitting replacement. For example, when the cone semi-angle is approximately 30°, a half turn of one part relative to the other part is sufficient to either fully tighten the parts together or fully release the parts from each other, for threads which are sufficiently shallow.

### BRIEF DESCRIPTION OF THE DRAWINGS

Embodiments of the invention will now be described, by way of example, with reference to the accompanying figures in which:

FIG. 1 shows schematically a wet-change plasma welding or cutting torch tool known in the art;

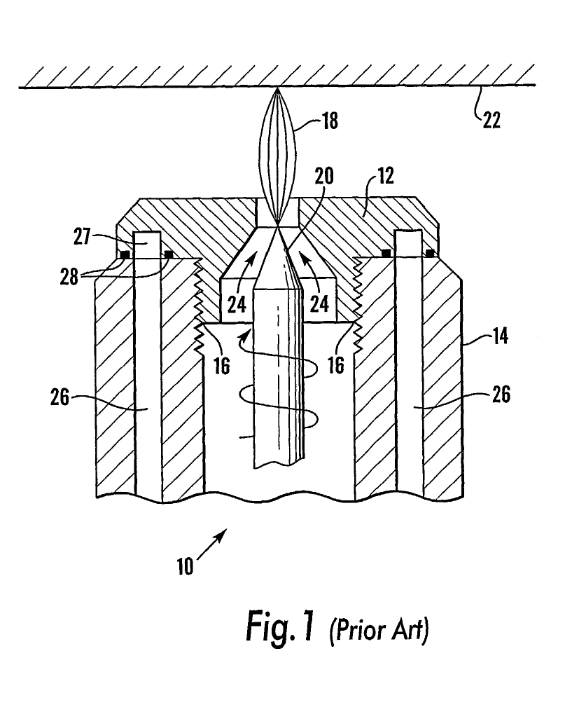

FIG. 2 shows schematically a dry-change or plasma welding or cutting torch tool known in the art;

FIG. 3 shows schematically a MIG/MAG welding torch tool known in the art;

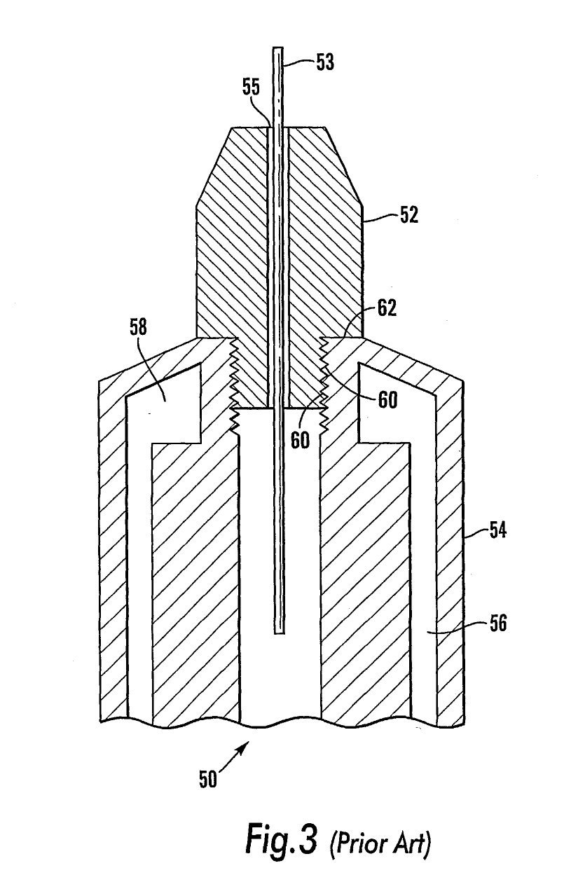

FIG. 4 shows schematically a plasma welding or cutting torch tool embodying the present invention;

FIG. 5 shows an alternative nozzle in detail for the tool of FIG. 4;

FIGS. 6a and 6b show schematically possible forms of thread for thermal tools of the invention; and

FIG. 7 shows schematically a spot welding device embodying the present invention.

### BEST MODES FOR CARRYING OUT THE INVENTION

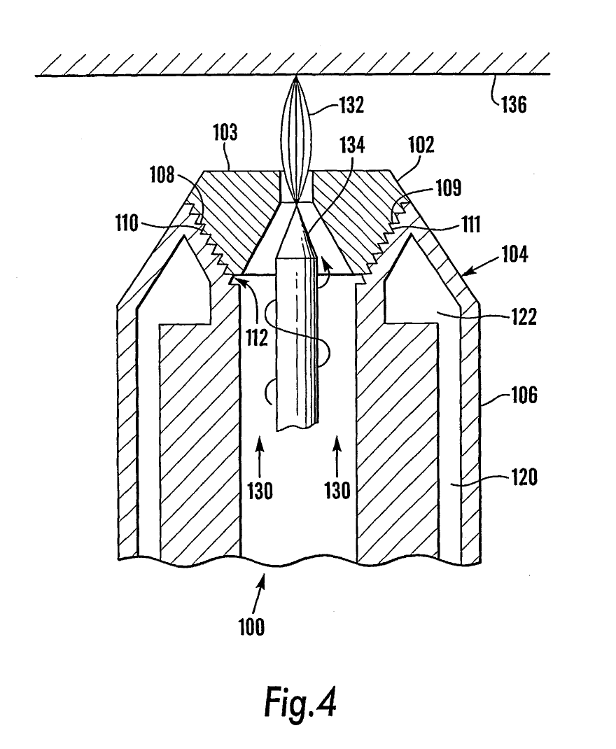

FIG. 4 shows schematically a plasma welding or cutting torch tool 100 embodying the present invention. The tool 100 comprises a replaceable nozzle 102, with a tip region 103, which is coupled to the leading end 104 of elongate support 106. The nozzle has a male screw portion 108 with a frusto-conical profile, and the leading end 104 of elongate support 106 has a complementary female screw portion 110. The inner periphery 112 of female screw portion 110 defines a frusto-conical recess for receiving the matching profile of the male screw portion 108. The screw-threads 109,111 of the male and female portions 108,110 are interengaged through relative rotation so that the replaceable nozzle 102 is supported and held by the elongate support 106. The tip 103 of the nozzle may be fully exposed during use to the very hot workpiece and so the heat transfer from the nozzle 102 to the fluid cooled support 106 is maximised.

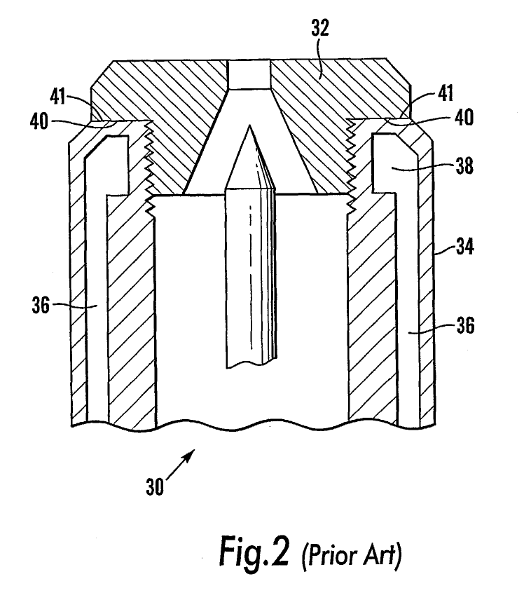

The tool 100 is a dry-change, fluid-cooled arrangement and in this regard is comparable to the known arrangement shown in FIG. 2. In the FIG. 4 arrangement, the leading end 104 of the elongate support 106 thus includes a closed coolant fluid supply channel 120 terminating in annular chamber 122, which surrounds and is as close as possible to the threads 109,111 of the threaded portions 108,110. In use, gas 130 flowing through the nozzle 102 is ionised by an arc 132 from electrode 134 and propelled towards workpiece 136. Heat energy accumulating in the nozzle 102 is dissipated through the interengaging screw portions 108,110 and into the leading end 104 of support 106. At the same time, heat received is conducted away from the leading end 104 by circulating coolant through chamber 122 and away from the leading end 104 of the elongate support.

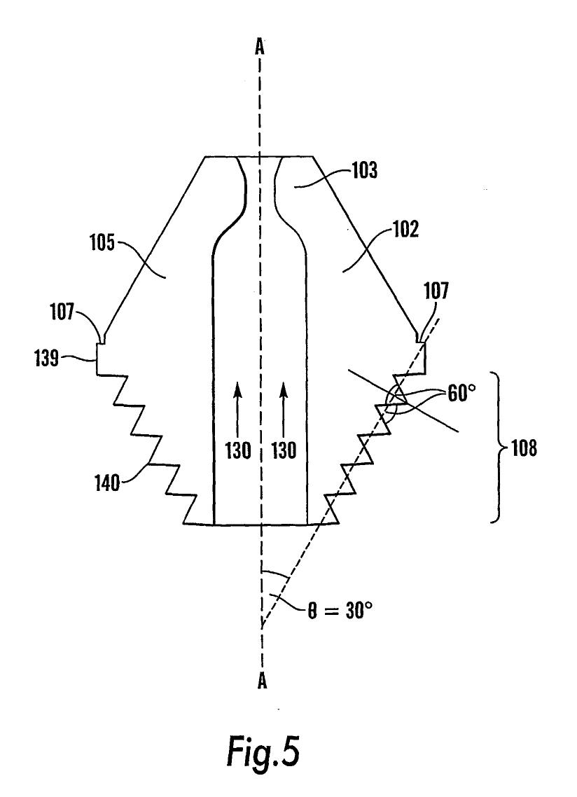

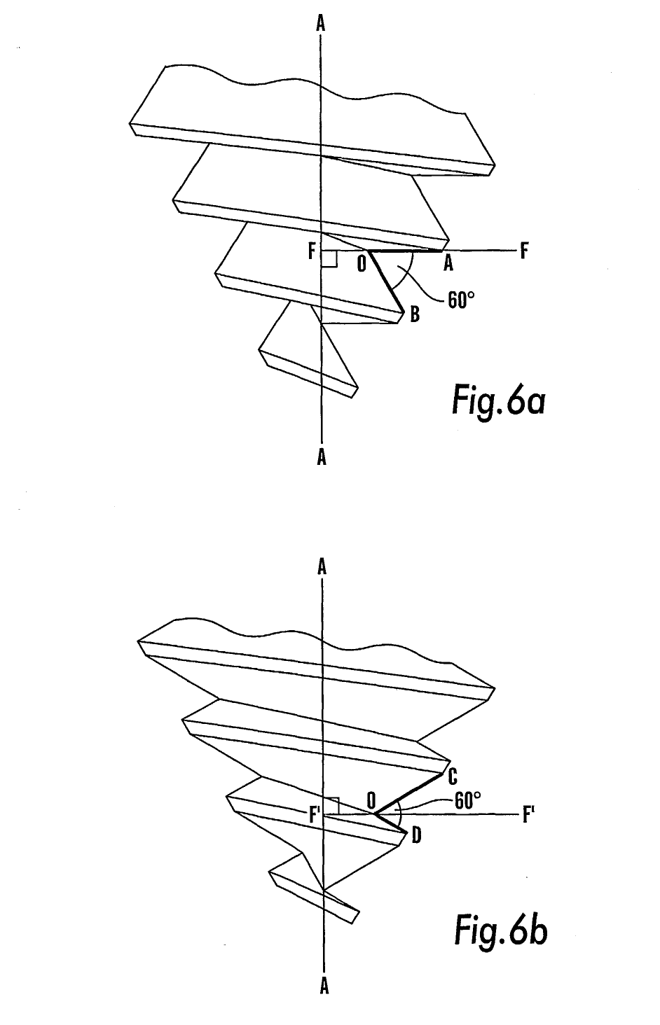

FIG. 5 shows cross-sectional detail of an alternative nozzle 102, the section being taken parallel to and along central axis A-A. In common with the nozzle of FIG. 4, the male screw portion 108 with a frusto-conical profile has a buttress-type (as herein defined) screw-thread 140, and also the curved periphery of the male screw portion 108 is inclined at an angle of substantially (ie. approximately) 30° to the central axis A-A Thus, bearing in mind that the central axis is also the rotation axis, the cone half angle is also substantially 30°. The female screw portion 110 is inclined at a complementary angle to mate with the male screw portion 108. In the FIG. 5 nozzle, a conical portion 105 including the tip region 103, which may be exposed during use, leads to the screw-threaded portion 108. The sides of the threads may be flattened, which improves robustness, as shown in FIG. 6a. The conical region 105 may be gripped easily for example in recesses 107 next to the cylindrical central portion 139, and so the nozzle can be readily changed.

In FIG. 6a a buttress-type, 60° thread form is illustrated; in FIG. 6b another 60° thread form is shown, having the same pitch as FIG. 6a. A pair of adjacent flanks belonging to neighbouring threads is indicated for convenience in each case by a heavy line. With the buttress type of thread, the axis F-F through the front (or thrust) flank is approximately 90° to the cone axis A-A and so a greater surface area of contact exists between the threaded parts, resulting from longer flank OB in comparison with flank OD. In comparison, in the non-buttress, 60° thread form, the axis F′-F′, herein referred to as the thread form axis, is 90° to the cone axis A-A. The greater surface area allows greater heat transfer (and electrical current when applicable). As seen in the Figures, AOB is longer than COD.

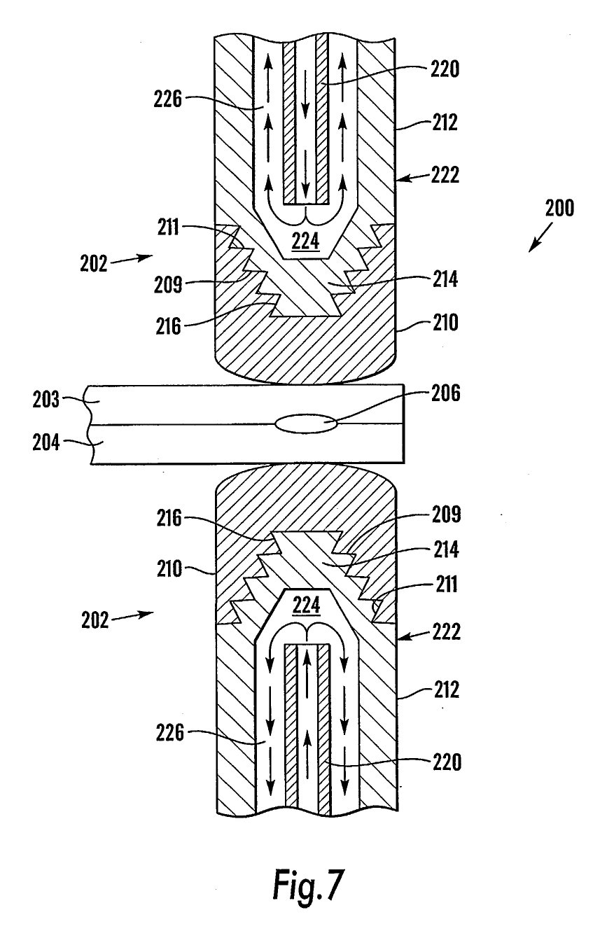

FIG. 7 shows schematically another embodiment which is a spot (resistance) welding apparatus 200 which comprises two shaped electrodes 202 which clamp two sheet-like workpieces 203,204 therebetween. A weld is formed by passing current between the electrodes which causes the formation of a pool of molten metal 206 at the interface between the two workpieces 203,204, where the electrical resistance is higher. The electrodes 202 are manufactured from good electrical and heat-conducting material such as copper or its alloys and are water-cooled internally to prolong electrode life.

Each electrode 202 comprises a replaceable cap 210 which is mounted on elongate support 212 via interengaging screw-threads 209,211. In the arrangement shown, the elongate support 212 has a screw-threaded portion 214 with a frusto-conical profile, and the replaceable cap has a complementary screw-threaded recess 216. The elongate support 212 has a blind bore comprising inner coolant supply conduit 220 delivering water coolant to the leading end 222 of the support 212 adjacent and surrounded by the threads 209,211. Water circulates in chamber 224 before passing through outer conduit 226 of the blind bore, back down the support 212. Once again, the replaceable part (i.e. the cap 210) is not in contact with the water coolant, so dry-changing is possible.

This is believed to be an improvement over the existing arrangement where the cap is traditionally forced onto a tapered tube which has a bore extending therethrough. In the absence of a blind bore in the known arrangement, dry-changing of the replaceable part is not possible. The arrangement shown in FIG. 7 makes for simple and reliable removal and replacement of the cap 210, for example when the existing cap becomes worn or otherwise damaged.

It will be clear to the person skilled in the art that the features of the threaded portions of the first and second parts as described above, according to the invention, may be employed in various thermal tools including a replaceable nozzle or cap, notwithstanding the method of supply of heat from the tip region of the tool.

1. A tool (100) for thermally working a workpiece, comprising a first part (102) which becomes heated during tool operation, and a second part (106) configured to support and conduct heat away from the first part when heated during tool operation, the parts having complementary, screw-threaded portions (108,110), which interengage when the first part (102) is supported by the second part (106), characterised in that the screw-threaded portions (108,110) each have a substantially conical or frusto-conical profile with a cone semi-angle of at least 10°.

2. A tool according to claim 1, in which the cone semi-angle is substantially 30°.

3. A tool according to claim 1 or claim 2, in which at least one of the complementary screw-threaded portions has a buttress-type screw-thread (as hereinbefore defined).

4. A tool according to claim 3, wherein the back of the thread slopes at an angle to the screw axis of 60°.

5. A tool according to any one of the preceding claims, in which the second part includes a heat sink adjacent the screw-threaded portion.

6. A tool according to claim 5, in which the heat sink includes a fluid supply conduit through which fluid may be circulated to facilitate cooling of the first part.

7. A tool according to claim 6, in which the fluid supply conduit terminates within the second part and surrounds the interengaging screw-threaded portions.

8. A tool according to any one of the preceding claims, in which the parts are adapted for welding or non-contact cutting.

9. A tool according to claim 8, in which the welding tool is selected from the group consisting of a plasma welding torch, a plasma cutting torch, a laser welding device, a laser cutting device, a MIG welding torch, a MAG welding torch, a spot (resistance) welding device, a TIG welding torch, and combinations thereof.
